(19) United States
(12) Patent Application Publication
(10) Pub. No.: US 2010/0304004 A1
(43) Pub. Date: Dec. 2, 2010

(54) WHOLE SUGAR

(75) Inventors: Bernardo Quintero Balcazar, Condominio Santa Barbara (CO); Humberto Francisco Benitez Bueno, Valle (CO); Vivian Alexandra Posso Trujillo, Valle (CO); Gabriel Arguello Gamboa, Valle (CO); Hernando Cardenas, Valle (CO)

Correspondence Address: QUARLES & BRADY LLP, 33 E. MAIN ST, SUITE 900, P.O BOX 2113, MADISON, WI, 53701-2113, US

(73) Assignees: CENTRAL CASTILLA S.A., Cali (CO); INTERCONTINENTAL SUGAR USA, LLC, Wilmington, DE (US)

(21) Appl. No.: 12/095,591

(22) PCT Filed: Dec. 1, 2006
(86) PCT No.: PCT/US2006/046258

§ 371 Date: Aug. 20, 2010

Related U.S. Application Data
(60) Provisional application No. 60/741,148, filed on Dec. 1, 2005.

(51) Int. Cl. A23L 1/09

(52) U.S. Cl. 426/658; 426/465; 426/473

(57) ABSTRACT

A whole sugar contains saccharose and additional ingredients from sugar cane not found in conventional raw, white, refined, or amorphous sugars. Processes for making the whole sugar are disclosed.

### CROSS REFERENCE TO RELATED APPLICATION

This application claims the benefit of U.S. Provisional Patent Application No. 60/741148, filed Dec. 1, 2005, which is incorporated herein by reference as if set forth in its entirety.

### BACKGROUND OF THE INVENTION

The present invention relates generally to a crystallized whole sugar and to methods for producing the sugar. The whole sugar contains a plurality of reducing sugars, and minerals, and has a characteristic organoleptic flavor, color and scent like sugar cane syrup. In contrast, conventional raw or white sugar contains at least about 98 percent, often at least about 99.7 percent saccharose (also known as sucrose), but is substantially free of other sugars and minerals.

Raw and white sugars are conventionally produced from cleaned sugar cane. Harvested sugar cane is wet- or dry cleaned to eliminate vegetable and mineral impurities from the harvested cane. The cleaned cane is chopped and shredded to release fibres. Cells in the fibres and in the rind are opened, and squeezed, for example in a mill, to extract raw juice that contains saccharose, minerals, vitamins, organic acids and waxes. The extraction process typically opens more than about 75 percent of the cells in the chopped cane and at least about 90 percent of the cells in the shredded cane.

Water is added to the raw juice and the diluted raw juice is decanted to obtain a clear juice and mud. The mud is filtered in rotatory vacuum filter to produce a filter cake and a filtered juice that is sent to a limed juice stage. The clear juice is concentrated by evaporation to form a syrup from 15° Brix (concentration of dissolved solids) to 65° Brix. The syrup is clarified, for example by phosphoflotation with a flocculent polymer—and a mixture of lime and phosphoric acid—that traps the impurities in high molecular weight aggregates. The aggregates can be removed in a flotation clarifier when exposed to air by microinjection. For a related clarifying process, see U.S. Pat. No. 6,146,645, incorporated by reference in its entirety as if set forth herein.

Under controlled temperature and pressure, water is removed from the clarified syrup using a vacuum pan, to further concentrate the solids and to induce saccharose crystal growth in a crystal-rich massecuite. The massecuite is centrifuged to separate saccharose-crystal-containing syrup from molasses. To maximize saccharose recovery, the concentration and centrifugation steps (together, a purging cycle) are carried out three times, designated A, B, and C. After the A massecuite is centrifuged, crystal saccharose (sugar) is recovered, dried and packed. Depending on the quality of the starting material and on whether a color reducing agent is employed in the process, the recovered sugar can be a white sugar (color ranging between 80 UI and 250 UI), or a raw sugar (average color of about 2000 UI). UI designates International Units associated with the analytical method of ICUMSA (International Commission for Uniform Methods of Sugar Analysis). Saccharose crystals are repeatedly separated from the remaining syrup, so each successive purging cycle yields a seed having relatively less saccharose and relatively more non-saccharose nutrients, reducing sugars (glucose and fructose) and impurities. Accordingly, the saccharose-containing material recovered after the B- and C massecuites are centrifuged (referred to as the B- and C-seeds, respectively) are incorporated back into A- and B massecuites, respectively, to encourage development of increasingly larger saccharose crystals. A typical final (or purge) molasses separated during the C centrifugation contains 87 percent solids, including 25 percent to 33 percent saccharose, as well as reducing sugars like glucose and fructose, minerals, and cane impurities from the fields. Because of its high nutritional value, the final molasses is used mainly as raw material for balanced animal food. Clarified final molasses can be prepared by diluting the final molasses to 60° Brix, heating to 90° C., and then clarifying by phosphoflotation (as described, supra) or by sedimentation, depending upon the concentration of soluble solids and viscosity. Refined sugar can be prepared from raw sugar by melting the raw sugar in hot water and clarifying the resulting syrup by flotation, purification and decoloration in high retention filters to obtain a refined liquor. Saccharose is recovered from the refined liquor via the same repetitive purging cycles as were described for the direct white or the raw sugar. The refined sugar (“refino”), having a color below 45 UI, is then dried and packed.

In addition to such sugars, amorphous sugar is popular in Portugal and Brazil, and has been known in Portugal since the end of the 17th century. In modem Brazilian methods, raw sugar and/or direct white sugar are melted, clarified and double filtered with old process of deep bed and resins to produce a clear and bright liquor. The liquor is concentrated, for example in a falling film- or plate evaporator, to produce a concentrated liquor from 65° to 80° Brix. The concentrated liquor is boiled at a temperature above about 125° C. in the presence of a whitener (up to about 30 g/ton) to produce a massecuite having a color below 40 UI. The massecuite thus produced is crystallized rapidly, for example in a vertical crystallizer for 45 seconds, and then agitated for at least several minutes at a speed below about 50 rpm to avoid fainting lumps of sugar. Any lumps are separated and the amorphous product is dried to a final humidity (water content) of 0.15% bringing the temperature up to about 60° C., then cooling to 45° C. The amorphous product is dispersed through a mesh (0.25-0.45 mm) to yield a final product having a typical polarization of 99 and color of 60 UI. The remaining lumps are melted.

Portuguese amorphous sugar is made from refined sugar, using a different process than is used in Brazil. To produce Portuguese amorphous sugar, refined sugar syrup at 75° Brix is concentrated for 50 minutes under vacuum to a temperature of 105° C. to 92° Brix to produce an supersaturated massecuite. The massecuite is crystallized into amorphous crystals, for example in an aerator or crystallizer at 6 rpm under vacuum as the temperature is reduced to 60° C. with a humidity of 3.5%. The remaining operations are similar. The final product has a polarization of 96° Z-97° Z and a color of 2000-2500 UI.

All of the foregoing sugars are composed principally of saccharose, but in the process of producing such sugars, other beneficial sugars, elements, vitamins, minerals and nutrients found in sugar cane are discarded. It would be desired to produce a sugar that retains such sugars, elements, vitamins, minerals and nutrients.

### BRIEF SUMMARY OF THE INVENTION

The present invention is summarized in that a solid crystalline whole sugar having a saccharose purity of at least about 83% or at least about 90% or a least about 95% contains vitamins, minerals, nutrients and other minor elements of sugar cane that are substantially absent from conventional sugars. Unlike conventional sugars, centrifuged whole sugar has nutritious and therapeutic properties, and organoleptic flavor, scent and taste characteristic of sugar cane syrup. The whole sugar spontaneously crystallizes, has a typical polarization of at least about 83° Z and a color of at least about 5,000 UI or between about 5,000 UI and about 7,000 UI, depending on the starting materials used. Like conventional sugars, centrifuged whole sugar is suited for use as a sweetener or as an energy source.

The invention is further summarized in that a process for making the whole sugar can employ intermediate products of a conventional sugar production process, as disclosed infra.

### DETAILED DESCRIPTION OF THE INVENTION

A method for producing whole sugar of the invention, which is advantageously but not essentially carried out in parallel and simultaneous with a traditional sugar production process, includes the steps of:

heating a saccharose-containing base syrup having a purity of at least about 83 percent and a Brix of 68° to 74° to form a supersaturated massecuite having a purity of at least about 83%; and

crystallizing whole sugar from the massecuite.

The base syrup includes but need not be limited to water, a B-seed having a saccharose purity (i.e., saccharose content per 100 g of dissolved solids) of at least about 83%, at least about 90%, at least about 92%, or at least about 94%, along with minerals and the like sought to be included in the whole sugar, and at least a by-product of a purging cycle, evaporating or milling step of a traditional sugar production process. These by-products are suitable and desirable sources of additional saccharose, minerals and the like, but these components can be added as supplements to a syrup such that a syrup having sufficient saccharose purity and concentration is formed. The by-products typically have a purity lower than that of the B-seed, for example, in the range of about 32% to about 89%. In a typical base syrup, between about 59% and about 73%, or between about 64% and about 73%, of the syrup (by weight) is a B-seed, between about 1% and about 20%, or between about 1% and about 10%, of the syrup is a material of lower purity and the balance is water. In a special case, when the base syrup includes B-seed and cane juice without added water, endogenous water can be evaporated to reach supersaturation. As noted, small quantities of one or more vitamins, minerals, and the like can be included as supplements. Another by-product suitable for use is refilled liquor.

Representative characteristics of some by-products of a conventional sugar production process are shown in Table 1. The skilled person will appreciate that the % purity, ° Brix and % saccharose of the by-products can each vary from batch to batch, e.g., by about 0.1 to 5%.

TABLE 1

| By-product | % Purity | ° Brix | % Saccharose |
|---|---|---|---|
| Cane juice | 89 | 15 | 13.3 |
| Syrup | 88 | 58 | 51.0 |
| A Molasses | 76 | 76 | 58 |
| B Molasses | 53 | 76 | 40 |
| Final Molasses | 32 | 87 | 28 |
| C Seed | 78 | 93 | 72 |
| A Massecuite | 89 | 92 | 82 |
| B Massecuite | 58 | 96 | 56 |
| C Massecuite | 76 | 93 | 71 |
| Crystal | 66 | 89 | 59 |

Table 2 describes several typical, suitable base syrups and the respective contributions by weight percent of the components, but is not intended to embrace the full range of possible syrups. As noted, the purity and Brix of the components can vary, as can the purity and Brix of the base syrup produced.

TABLE 2

| Syrup # | Saccharose source | Intermediate product(s) | Water |
|---|---|---|---|
| 1 | B-seed (94% purity) [66.7%] | Clarified Final molasses (32% purity) [0.6%] | [22%] |
| | | Cane Syrup (88% purity) [10.7%] | |
| 2 | B-seed (94% purity) [71%] | Clarified Final molasses (32% purity) [0.7%] | [25.6%] |
| | | A-molasses (77.5% purity) [2.7%] | |
| 3 | B-seed (94% purity) [73%] | Clarified Final molasses (32% purity) [1.25%] | [25.75%] |
| 4 | B-seed (94% purity) | B-molasses (53% purity) [1.1%] | [25.9%] |
| | [72.4%] | Clarified Final molasses (32% purity) [.6%] | |

The saccharose crystals can be readily dissolved in the syrup by continuous agitation. An antifoaming agent can be added after dissolution.

The syrup can be supersaturated by known atmospheric- or vacuum supersaturation methods to produce a massecuite having a residual water content in the range of about 2 to about 6%, until crystals form spontaneously, at about a concentration of at least 94% solids. In an atmospheric method, the syrup at atmospheric pressure can be heated to a temperature between about 126° and 155° C. with live steam (100 psig/190° C.) for a time sufficient to obtain the massecuite. In a vacuum method, the syrup can be maintained in a vacuum (less than 25 in. Hg) at a constant temperature between about 56° C. and about 98° C. heated with saturated steam (15 psig/120° C.) to obtain the massecuite. In the final stage of boiling, the vacuum is released and the temperature of the massecuite is raised to at least 105° C.

The massecuite is cooled until it spontaneously crystallizes with heat liberation by natural or induced convection, radiation or conduction, or a combination thereof (e.g., using heat-conductive fluid, direct air injection, or the like) at atmospheric pressure or under vacuum. During or after this cooling, the massecuite is divided under force into small particles, e.g., by agitation at between about 40-60 RPM, or by forming droplets from the mass in its liquid state, or by grinding the mass in its solid state. After crystallization, the centrifuged whole sugar has a residual humidity of less than about 1%.

The whole sugar is dried to a final residual humidity of 1.5% or less, or 0.2% or less, at ambient temperature to yield particles having a size in the range of about 0.18 mm-0.45 mm. Particles of the dried sugar can be further sieved before packing to remove any chunks that may have formed during crystallization. An analysis of a typical dried whole sugar follows in Table 3. The whole sugar contains, for example, policosanol that is beneficially associated with cholesterol management. This compound, like the minerals and nutrients, is not found in conventional white, raw or refined sugar.

TABLE 3

| Component | |
|---|---|
| Saccharose | Minimum 83% |
| Glucose + Fructose | Max. 3.5% |
| Calcium | 65 mg/100 g |
| Potassium | 240 mg/100 g |
| Sodium | 19 mg/100 g |
| Magnesium | 47 mg/100 g |
| Phosphorus | 7 mg/100 g |
| Iron | 0.95 mg/100 g |
| Policosanols | Max 500 mg/100 g |

We claim:

1. A method for producing whole sugar includes the steps of:
removing water from a base syrup to form a supersaturated massecuite, where the base syrup has a concentration of dissolved solids in the range of about 68% to about 74% and contains a B-seed and at least one other product of a purging, evaporating or milling step of a conventional sugar production process; and
crystallizing whole sugar from the massecuite.

2. A method as claimed in claim 1 wherein the at least one product is selected from the group consisting of a concentrated sugar cane juice, a clarified sugar cane juice, a syrup, A massecuite, B massecuite, C massecuite, A molasses, B molasses, clarified final molasses, and refined liquor.

3. A method as claimed in claim 1 wherein the base syrup is supersaturated in a method performed at atmospheric pressure.

4. A method as claimed in claim 1 wherein the base syrup is supersaturated in a method performed under vacuum.

5. A method as claimed in claim 1 wherein the crystallizing step includes the steps of cooling the massecuite until it spontaneously crystallizes and obtaining particles from the crystallized massecuite.

6. A whole sugar made according to a process comprising the steps of:
removing water from a base syrup to form a supersaturated massecuite, where the base syrup has a concentration of dissolved solids in the range of about 68° to about 74° and contains a B-seed and at least one other product of a purging, evaporating or milling step of a conventional sugar production process; and
crystallizing the whole sugar from the massecuite.

7. A whole sugar as claimed in claim 6 wherein the at least one product is selected from the group consisting of a concentrated sugar cane juice, a clarified sugar cane juice, a syrup, A massecuite, B massecuite, C massecuite, A molasses, B molasses, clarified final molasses, and refined liquor.

8. A whole sugar as claimed in claim 6 wherein the base syrup is supersaturated in a method performed at atmospheric pressure.

9. A whole sugar as claimed in claim 6 wherein the base syrup is supersaturated in a method performed under vacuum.

10. A whole sugar as claimed in claim 6 wherein the crystallizing step includes the steps of cooling the massecuite until it spontaneously crystallizes and obtaining particles from the crystallized massecuite.

11. A whole sugar comprising at least 83% saccharose by weight, other reducing sugars, and minerals.
